(19) United States
(12) Patent Application Publication
(10) Pub. No.: US 2023/0384148 A1
(43) Pub. Date: Nov. 30, 2023

(54) EXTRACTING METHOD OF CHANNEL-FREQUENCY FEATURES IN DAS SENSORS

(71) Applicant: ASELSAN ELEKTRONIK SANAYI VE TICARET ANONIM SIRKETI, Ankara (TR)

(72) Inventors: Muhammet Emre SAHINOGLU, Ankara (TR); Mustafa AKUR, Ankara (TR); Abdulsamet DAGASAN, Ankara (TR)

(73) Assignee: ASELSAN ELEKTRONIK SANAYI VE TICARET ANONIM SIRKETI, Ankara (TR)

(21) Appl. No.: 18/325,148

(22) Filed: May 30, 2023

(30) Foreign Application Priority Data
May 30, 2022 (TR) 2022/008819

(51) Int. Cl. G01H 9/00

(52) U.S. Cl. CPC G01H 9/002; G01H 9/004

(57) ABSTRACT

A method for calculating channel-frequency feature for detecting multi channel (propagated spatially) activities in DAS sensor data is provided. This method can be generalized for linearly spaced sensor arrays. In the method, spectrograms of different channels are generated and frequency features are calculated for different time windows. In channel frequency image, frequency features are concatenated in spatial domain, so that horizontal axis represents the spatial dimension.

### CROSS REFERENCE TO THE RELATED APPLICATIONS

This application is based upon and claims priority to Turkish Patent Application No. 2022/008819, filed on May 30, 2022, the entire contents of which are incorporated herein by reference.

### TECHNICAL FIELD

The present invention is a method for extracting channel-frequency feature for linearly spaced sensors for detecting multi channel (propagated spatially) activities.

### BACKGROUND

Distributed Acoustic Sensing (DAS) is a technology that detects acoustic vibrations along a fiber optic cable. This enables us to treat fiber optic cable as an array of linearly spaced seismic sensors. Data coming from DAS sensors has spatio temporal features so that various signal processing techniques can be applied. Array characteristic of the sensor data are useful for applications such as earthquake detection, earthquake center detection; train detection, train tracking, in railways.

Distributed acoustic sensing (DAS) collects data of seismic signals on fiber optic cable which covers up to 50-100 km range. Vibrations on the cable cause phase differences on the laser beam transmitted and obtained phase differences model the activity in the field. The arrival time of the beam which phase difference is measured, to the sensor, indicates from which location the beam is reflected on the fiber optic cable. As a result, the sensor collects independent measurements of each 10 m section, through 50 km cable line. Parts which are 10 m, are named as channel. As a result of these processes, the sensor can be treated as a linearly spaced microphone array that consists of 5000 microphones which each one listens 10 m part.

DAS sensors are used in different applications due to its passive nature and large coverage. DAS sensors, are used to detect intrusions such as digging or excavation, in pipeline security applications, to detect humans and vehicle in border security applications, the sensor can be used to detect climbing or cutting activities on fence in facility security purposes.

In general, DAS sensors independently process the signals coming from different channels. This approach performs well in case of propagated not spatially activities such as walking, digging, etc. However, seismic signals that are propagated over larger areas such as earthquakes or the vibration of trains require multi channel processing of the signals. Instead of fusing higher level features, such as signal power or activity probabilities calculated for each channel, using lower level features without losing information promises a better solution.

The application numbered WO2012022934A2 describes a system for moving object detection, comprising an interrogator system adapted to provide distributed acoustic sensing on a fibre optic cable, arranged along a border. The measurement signals from each of a plurality of sensing portions of said fibre are analysed to determine a characteristic of a Doppler shift. The characteristic of a Doppler shift may be a continuous decrease in detected frequency. By detecting the time at which the rate of change of frequency is at a maximum for each of the sensing portions, the time of closest approach of the object to those sensing portions can be determined. The distance of closest approach and velocity can be determined. However, the application has not addressed on extracting channel-frequency image that allows implementation of advanced image processing techniques for detecting multi channel activities.

### SUMMARY

The present invention proposes a method for calculating channel-frequency feature for detecting multi channel activities in DAS sensor data. This method can be generalized for linearly spaced sensor arrays. In the method, spectrograms of different channels are generated and frequency features are calculated for different time windows. In channel frequency image, frequency features are concatenated in spatial domain. As a result of said process horizontal axis, axis represents the spatial dimension, not the time dimension unlike classical spectrogram images.

### BRIEF DESCRIPTION OF THE DRAWINGS

FIGS. 1A and 1B show spectrogram extracted from the seismic signals of a train in different channels.

FIG. 2 shows flow chart of channel-frequency feature extraction.

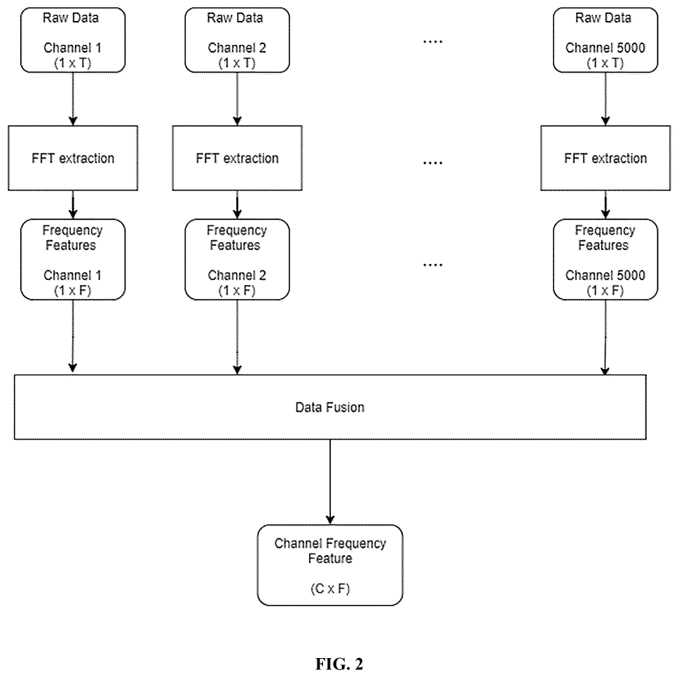

FIG. 3 shows graph of channel-frequency feature of a train.

### DETAILED DESCRIPTION OF THE EMBODIMENTS

In railway applications, DAS sensors are becoming popular due to wide distance of sensing. Continuous monitoring of railway and train conditions and detecting anomalies improves the safety in railway transportation. Estimation of train location, speed, number of wagons and detection of flat wheels, broken rails constitute main application areas of DAS sensor in railways. For these tasks, DAS sensors offer great potential with high performance.

In order to exploit the advantage of wide range coverage of DAS sensors, sophisticated algorithms and fast computation techniques are required. Traditionally, signal processing techniques are applied on seismic signals but recently machine learning approaches outperforms the other techniques. Machine learning approaches also allow better feature extraction in spatial dimension.

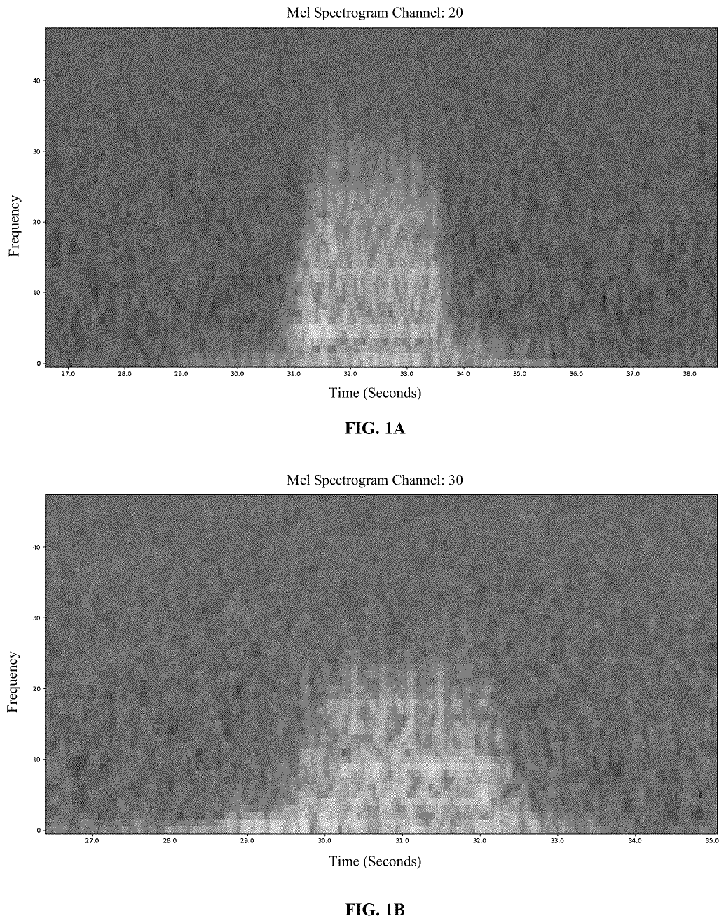

In audio applications, spectrogram is a widely used representation of time series data where one dimensional time domain signals are converted to 2-dimensional time-frequency features. In a spectrogram, FFT magnitudes of short time windows are concatenated horizontally by sliding the window. In FIGS. 1A and 1B, we see spectrograms extracted from the seismic signals of a train. In DAS sensors instead of single channels, we have time series data from multiple channels.

Spectrograms represent data in time frequency domain. In DAS sensors, there exists one more dimension, spatial dimension, due to multiple channels. Calculating the spectrograms of different channels generates three dimensional data (Channel, Time, Frequency).

In this work, a channel frequency feature extraction method for estimating multi-channel activities in DAS sensor data is proposed. This method utilizes the linearly spaced channel features of DAS sensor and the method is not applicable for other sensor geometries. This interpretation of data enables the adaptation of commonly used advanced image processing techniques. Processing channel-frequency features in different time frames is similar to video processing.

In spectrogram images, frequency features are calculated for different time windows. In channel-frequency image, frequency features are concatenated in spatial domain, so that horizontal axis represents the spatial dimension.

In proposed algorithm, FFT of each channel is calculated for T samples. If magnitudes of frequency content are calculated, F=T/2+1 frequencies extracted for each channel. Then frequency bins are concatenated in spatial dimension so that C×F channel-frequency image is extracted.

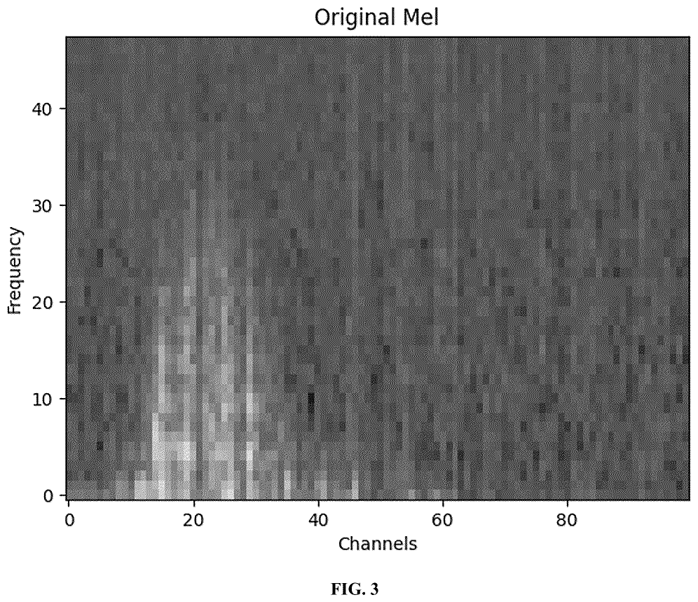

If there is an activity that spans multiple channels, it has a specific signature in channel-frequency image of said activity. In FIG. 3, channel-frequency feature of a train which has a length of 200 m can be seen. The proposed channel-frequency feature has a better representation of raw data and allows implementation of advanced image processing techniques. It can be applicable for linearly spaced sensor geometries and provides a rich feature space due to the fusion of data obtained by multiple channels.

1. A method for extracting a channel-frequency feature for linearly spaced sensors for detecting multi channel activities, comprising steps of:
calculating spectrograms of linearly spaced channels for different time windows to generate three dimensional data as a channel, a time, a frequency,
concatenating frequency bins in a spatial dimension to extract a channel-frequency image.
